(19) United States
(12) Patent Application Publication
(10) Pub. No.: US 2023/0285793 A1
(43) Pub. Date: Sep. 14, 2023

(54) BARBELL HAVING A QUICK-CLAMPING NUT FOR CLAMPING THE WEIGHTS

(71) Applicants: Moritz GRESSER, Baienfurt (DE); Marcel WAHL, Baienfurt (DE)

(72) Inventors: Moritz GRESSER, Baienfurt (DE); Marcel WAHL, Baienfurt (DE)

(21) Appl. No.: 18/041,604

(22) PCT Filed: Mar. 17, 2022
(86) PCT No.: PCT/EP2022/057077

§ 371 Date: Feb. 14, 2023

(30) Foreign Application Priority Data
Apr. 7, 2021 (DE) 10 2021 108 688.4

(51) Int. Cl. A63B 21/072; F16B 37/08

(52) U.S. Cl. CPC A63B 21/0728; F16B 37/0814

(57) ABSTRACT

A barbell as a piece of sports equipment for training and/or for taking part in competitions, having a bar for releasably and/or exchangeably holding weights, wherein the bar has at least one external thread having at least one weight, which has an opening for sliding onto and pulling off the bar, and having at least one clamping nut so as to hold and/or secure the respective weight, to be held on the bar, by clamping the clamping nut introduced onto the external thread with respect to the weight, characterized in that the clamping nut is in the form of a quick-clamping nut which has a through-opening with an internal thread.

### CROSS-REFERENCES TO RELATED APPLICATIONS

This Application is a Section 371 National Stage Application of International Application No. PCT/EP2022/057077, filed Mar. 17, 2022, and published as WO 2022/214294 A1 on Oct. 13, 2022, and claims priority to German Application No. 10 2021 108 688.4, filed Apr. 7, 2021, the contents of both are hereby incorporated by reference in their entirety.

### BRIEF DESCRIPTION OF THE DRAWINGS

FIG. 1 shows a sectional view of a clamping nut according to one example.

FIG. 2 shows a plan view of a clamping nut according to one example.

FIG. 3 shows a clamping nut in the disengaged position on a part of a barbell in a side view of a part of a barbell.

FIG. 4 shows the arrangement from FIG. 3, wherein the clamping nut is in the engaged position.

FIG. 5 shows the arrangement from FIG. 3, wherein the clamping nut is clamped against the weight on the barbell bar.

FIG. 6 shows a plan view of a second exemplary embodiment.

FIG. 7 shows a sectional view of a second exemplary embodiment.

FIG. 8 shows a plan view of a third exemplary embodiment.

FIG. 9 shows a sectional view of a third exemplary embodiment.

### DETAILED DESCRIPTION

The present disclosure relates to a barbell as a piece of sports equipment for training and/or for taking part in competitions, having a bar for releasably and/or exchangeably holding weights and having at least one weight, and having a clamping nut so as to hold and/or secure the respective weight, to be held on the bar, by clamping the clamping nut with respect to the weight, according to the preamble of claim 1.

### PRIOR ART

Usually, a barbell having exchangeable weights, as is used for training or for taking part in competitions, consists of a barbell bar, two nuts and weights in the form of various weight plates. The barbell bar has a gripping part in the middle portion and an external thread in the two outer portions. Between the gripping part and each of the outer portions there is a ring, which serves as a stop for the weight plates. The weight plates, which are obtainable in different weights, have a central bore and can be pushed onto the external thread of the barbell bar as far as the respective stop. To secure the weight plates, a nut is screwed onto the external thread of the barbell bar on both sides. Such a barbell is known from DE 75 544 A.

Possible ways of more quickly fitting weight plates on barbell bars are known from DE 10 2011 013 859 A1, US 2011/0 224 053 A1 and US 2021/0 016 126 A1, but these all require special barbell bars.

By contrast, it is an object of the present disclosure to make it quicker and easier to change the weights.

Proceeding from a barbell of the type mentioned at the beginning, this object is achieved by the features of claim 1. Advantageous embodiments and developments of the present disclosure are possible by way of the features mentioned in the dependent claims.

Accordingly, a barbell according to one example of the present disclosure is characterized in that the clamping nut is in the form of a quick-clamping nut which has a through-opening with an internal thread, wherein the through-opening is flared at the ends of the through-opening such that the quick-clamping nut is displaceable along an insertion axis, which extends through the through-opening, without the internal thread being engaged with the external thread over and/or along the barbell bar, while the clamping nut is disengaged with respect to the bar and is in a disengaged position, and has a thread axis which extends through the through-opening, along which the external thread of the bar can be brought into engagement with the internal thread, wherein the thread axis intersects the insertion axis such that, by tilting the clamping nut about the intersection point of the insertion axis and the thread axis and about an axis perpendicular to the insertion axis and to the thread axis, the internal thread and the external thread can be brought into engagement and thus into an engaged position and/or can be released from one another.

In this case, the weights and the barbell bar can advantageously remain unchanged. The clamping nut allows easy placement on the barbell bar and quick clamping and releasing of the weights. According to the present disclosure, to achieve the object, inter alia, a barbell having the correspondingly optimized quick-clamping nut is provided.

The clamping nut can thus be pushed swiftly over the thread of the barbell bar with the aid of the flared through-opening, without needing to be laboriously screwed along the thread. This saves a great deal of time particularly when the weights which are intended to be fastened to the barbell are changed frequently, as is the case especially when training. After the clamping nut has been tilted about the intersection point of the insertion axis and the thread axis, the internal thread of the clamping nut engages in the external thread of the barbell bar, such that the clamping nut can be clamped against the weight arranged on the barbell bar. The tension built up in this way prevents it from tilting back from the engaged position into the disengaged position. The weights thus remain secured on the barbell bar, with the result that the risk of injury to the user is further minimized.

Preferably, a securing device for securing the clamping nut in the engaged position and counter to undesired tilting and releasing of the clamping nut from the engaged position is provided. Since the clamping nut cannot move out of its position and as result cannot be released, the safety of the barbell user is increased. The weights likewise cannot be released or even slip.

The securing device can in this case be configured such that it prevents the clamping nut from tilting back from the engaged position into the disengaged position, or such that the clamping nut secures the at least one weight against shifting axially in the engaged position. This can also take place when the clamping nut is not clamped in place against the weight.

The clamping nut is preferably obtainable by 3D printing and/or injection moulding and/or die casting and/or other primary forming methods. Thus, cost-effective and simple production can take place, in which a lightweight and yet stable clamping nut is obtainable.

It is also conceivable for the through-opening to be obtainable by drilling along the thread axis, cutting an internal thread about the thread axis and producing a thread-free through-hole along the insertion axis. Other manners of production are also conceivable, however.

Preferably, the nominal diameter of the internal thread corresponds to the nominal diameter of the external thread and/or the diameter of the thread-free through-hole corresponds to the nominal diameter of the internal thread and/or of the external thread. This ensures that the clamping nut on the one hand can be pushed precisely over the barbell bar in the disengaged position and on the other hand the internal thread thereof can be screwed into the external thread, without jamming, in the engaged position. Subsequent releasing of the clamping nut is also provided with such an embodiment.

In an advantageous embodiment, the internal thread has two partial threaded portions which are arranged opposite one another in an offset manner with respect to the thread axis, wherein the partial threaded portions each have an interrupted thread flight which has in each case an arc length of less than 360°. On the one hand, the two partial threaded portions can be arranged such that one partial threaded portion is arranged at one end of the through-opening and the other partial threaded portion is arranged at the other end of the through-opening. On the other hand, the two partial threaded portions can be arranged such that they are arranged about the thread axis with the respective centres of their arc lengths offset by 180°.

Conceivably, the intersection point of the insertion axis and the thread axis lies between the two partial thread portions. Thus, the centre of rotation of the clamping nut, in order to tilt the latter from the disengaged position into the engaged position, lies within the clamping nut.

Ideally, the clamping nut has a contact face which comprises a first and a second contact region, wherein the first contact region is formed perpendicularly to the thread axis and the second contact region is formed as a chamfer and/or as a rounding with respect to the first contact region such that, when the clamping nut is slid onto the bar, the second contact region can be brought into abutment against the weight and, when the clamping nut is tilted, in particular when the clamping nut is pivoted and/or tightened further against the weight, from the disengaged position into the engaged position, the first contact region can be brought into abutment against the weight. Thus, in the disengaged position, the clamping nut can easily be pushed over the barbell bar as far as the weight or as far as a short distance from the weight, without it having to be laboriously screwed over the thread. Subsequently, the clamping nut can be brought into the engaged position by being tilted and clamped against the weight in order in this way to prevent the weight from being released when the barbell is being used. The planar face can bear flat against the weight and the pressure that arises by the clamping of the clamping nut against the weight can be transmitted in a uniformly planar manner to the clamping nut. In this way, the clamping nut is less heavily loaded even at high pressure and can be used for a long time as a result. Since the second contact region is in the form of a chamfer or rounding with respect to the first contact region, the clamping nut can be positioned even closer to the weights in the disengaged position than would be the case if the contact face consisted only of a first contact region perpendicular to the thread axis.

Preferably, the chamfer forms a planar face perpendicular to the insertion axis. In such configuration, the second contact region can serve as a simple visual aid for the orientation in which the clamping nut needs to be held relative to the barbell bar in order that the clamping nut can be displaced over the external thread into the disengaged position, since the second contact region is formed perpendicularly to the insertion axis. Such a configuration then at the same time also helps the user when tilting the clamping nut, since the necessary tilting direction for changing position is discernible from the two contact regions.

The lateral face of the body of the clamping nut conceivably has at least one acting lever, extending in a plane perpendicular to the thread axis, for manually tightening and/or releasing the clamping nut. This acting lever can be arranged for example in wing-like manner or, in the case of a plurality of acting levers, in a star-like manner around the clamping nut.

Preferably, the lateral face of the body of the clamping nut has at least one acting lever, extending in a plane defined by the thread axis and the insertion axis, for manually tilting the clamping nut from the engaged position into the disengaged position and from the disengaged position into the engaged position.

In a preferred development of the present disclosure, the clamping nut, tilted with respect to the longitudinal axis of the bar or with the insertion axis parallel to the longitudinal axis of the bar, can be pulled over the region of the external thread without any screwing movement and subsequently tilted such that the external thread and internal thread are engaged and can then be screwed tight and clamped against the weight, since, after tilting, even the second contact region does not usually bear against the weight under tension. In this way, particularly stable fastening is achieved.

Advantageously, the lateral face of the body of the clamping nut has at least one C-shaped cutout for manually tightening and/or releasing the clamping nut.

Preferably, the securing device comprises a moulded element for receiving at least a part of the lateral face of the clamping nut in a form-fitting manner, and/or a securing cam and/or securing wedge and/or a C-clip for introducing into the through-opening along and/or parallel to the thread axis and/or the insertion axis, in order to prevent the clamping nut from tilting from the engaged position into the disengaged position and/or to prevent the releasing of the clamping nut from a position in abutment against the weight. The form-fitting reception prevents the clamping nut from accidentally being released. As a result of the non-releasing clamping nut, tilting of the clamping nut can be ruled out.

Preferably, the securing device has a tab and/or a snap-action hook and/or a spring, which keeps the clamping nut clamped with respect to the bar and/or prevents the tilting of the clamping nut, which causes it to be released from the engaged position, wherein, in particular, the tab and/or the snap-action hook and/or the spring is/are movable elastically and/or plastically relative to one another with respect to the clamping nut and bar, and/or wherein the tab and/or the snap-action hook and/or the spring is/are integrated into the clamping nut. In addition to physical securing, given a skilful choice of the shape of the securing device, tilting or releasing of the clamping nut can also be counteracted by additional force application on the clamping nut. Thus, the athlete's safety is increased when using the barbell for training and in competitions.

It is advantageous when at least one partial threaded portion has at least one thread flight which has an arc length of at least 180°, in order, in the engaged position, to allow the external thread of the bar to fit together with the internal thread by the retaining action of the undercut. It is also conceivable for two or more adjacent or spaced-apart thread flights to comprise a region with an arc length of 180° about the thread axis. Thus, it is possible to ensure that a sufficiently great holding action of the mutually engaging threads provides protection even against displacement of the barbell bar relative to the clamping nut.

Preferably, the clamping nut is manufactured at least partially, in particular entirely from a dimensionally stable plastic, in particular based on polyamide. Dimensionally stable plastic is both cost-effective and easy to produce and also to process and yet is stable, robust and durable.

### Exemplary Embodiment

An exemplary embodiment of the present disclosure is illustrated in the drawing and is explained in more detail in the following text with reference to the figures.

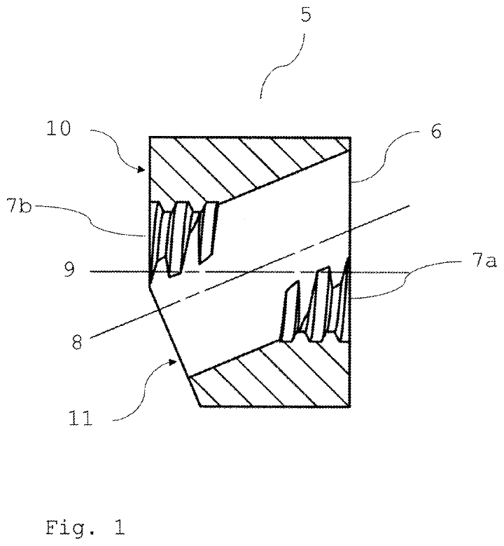

FIG. 1 illustrates a sectional view of a possible embodiment of a clamping nut 5 according to one example of the present disclosure. A through-opening 6 through the clamping nut 5 has two internal threaded portions 7a, 7b, which are located at opposite ends of the through-opening 6. The threaded portions 7a, 7b have the same thread properties and a common thread axis 9. The threaded portions 7a, 7b lie here with the centres of their arc lengths offset by 180° with respect to one another about the thread axis 9, such that the threaded portions 7a, 7b are opposite one another not only in the direction of the thread axis 9 but also perpendicularly thereto.

The through-opening 6 is flared at the ends such that a barbell bar 2 can be guided through the opening 6 along an insertion axis 8 without the external thread 4 of the barbell bar 2, which is complementary to the internal thread 7a, 7b of the clamping nut 5, engaging with the internal thread 7a, 7b of the clamping nut 5.

The clamping nut 5 also has a first and a second contact region 10, 11. The second contact region 11 is in the form of a chamfer of the first contact region 10.

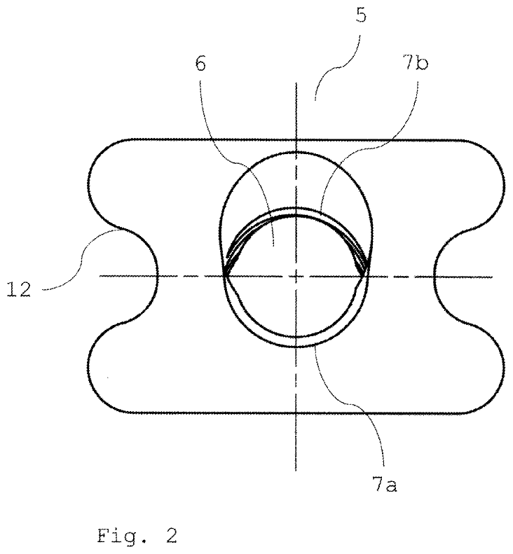

FIG. 2 shows the clamping nut 6 from FIG. 1 in plan view in the direction of the thread axis 9. Acting levers 12, which are C-shaped, are illustrated. On account of their shape, the acting levers 12 can be used both for manually tightening and for manually releasing the clamping nut 5.

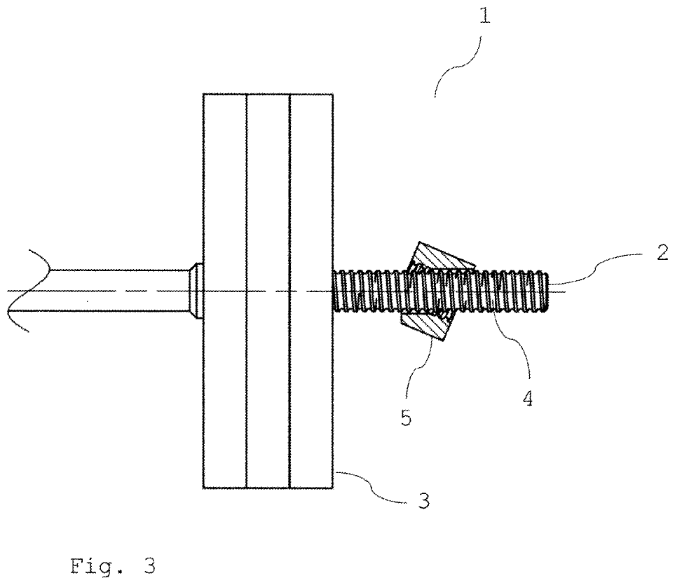

FIGS. 3-5 show the process of how the clamping nut 5 is fitted on a barbell 1. In FIG. 3, the clamping nut 5 is put on the barbell bar 2 in a disengaged position and displaced freely over the external thread 4 of the bar 2. This can take place either until the second contact region 11 of the clamping nut 5 is in contact with the weight 3 or until it is in the vicinity thereof.

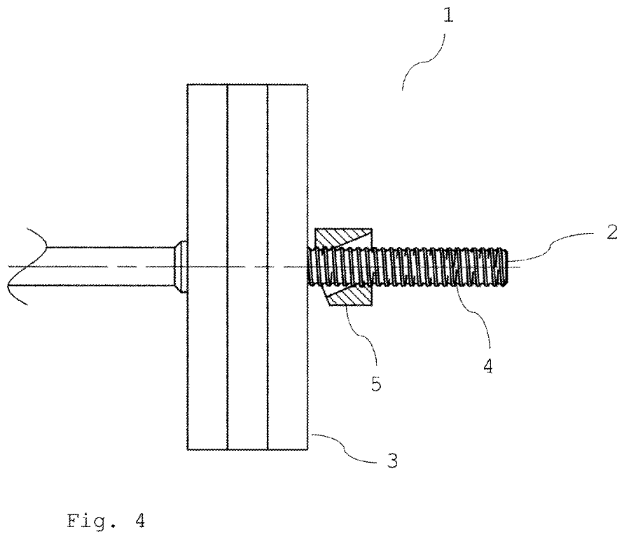

In FIG. 4, the clamping nut 5 is illustrated tilted into the engaged position in the vicinity of the weight 3. The internal threaded portions 7a, 7b of the clamping nut 5 and the external thread 4 of the barbell bar 2 are engaged with one another. In this position, the clamping nut 5 can be clamped against the weight 3 by being screwed along the external thread 4.

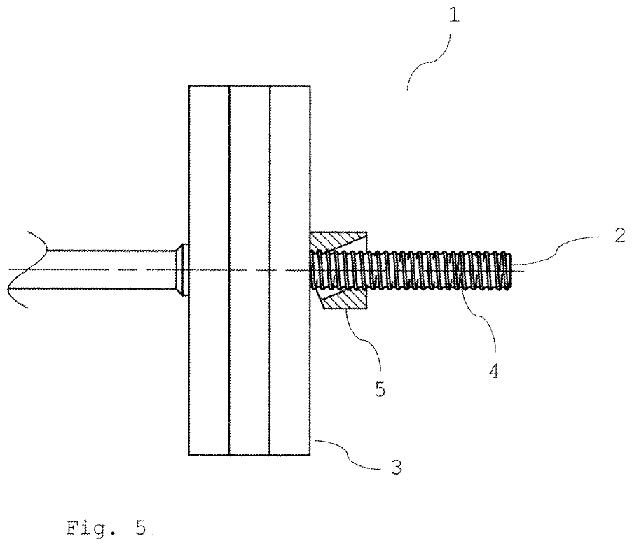

FIG. 5 shows the clamping nut 5 clamped in the engaged position against the weight 3. The contact of the first contact region 10 of the clamping nut 5 with the weight 3 prevents the clamping nut 5 from tilting back into the disengaged position again by itself. Accordingly, the clamping nut 5 can be released from the weight 3 at best by being screwed along the external thread 4.

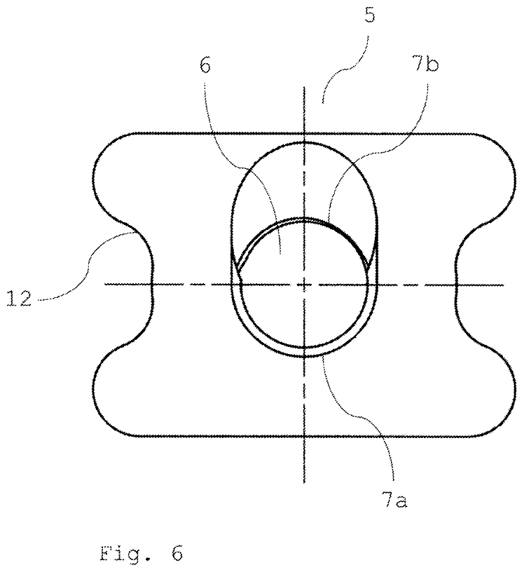

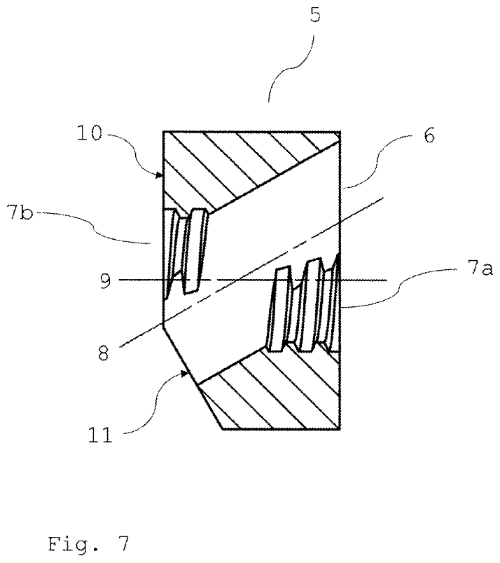

FIGS. 6 and 7 illustrate a further embodiment of a clamping nut 5. Compared with the clamping nut 5 from FIG. 1, the outermost thread flight of the internal threaded portion 7b has an arc length of more than 180°. As a result, the external thread 4 of the barbell bar 2 fits together with the internal thread 7a, 7b of the clamping nut 5 through the retaining action of the undercuts and thus the engaged position is secured.

In addition, the internal threaded portions 7a, 7b have fewer thread flights in the embodiment illustrated, but are not limited thereto. A reduced number of thread flights may, however, still be sufficient to bring about enough of a retaining action of the undercuts in the engaged position of the clamping nut 5.

Accordingly, it is also possible to increase the number of thread flights of the two internal threaded portions 7a, 7b. It is also conceivable for the two threaded portions 7a, 7b to be formed with a different number of thread flights from one another.

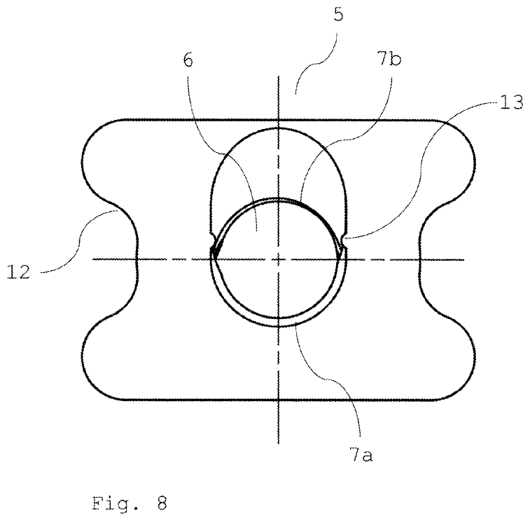

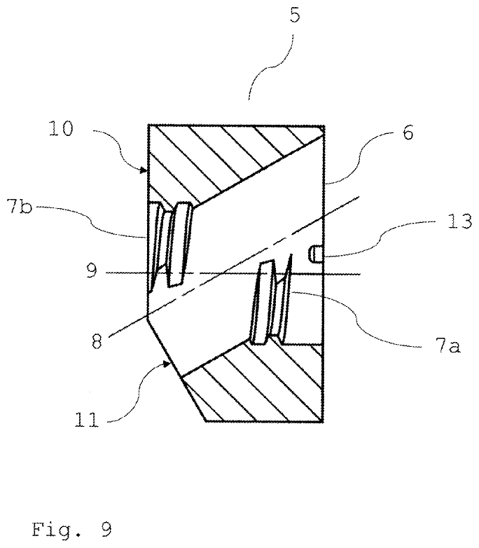

FIGS. 8 and 9 show a further exemplary embodiment of a clamping nut 5 having additional securing cams 13. The securing cams 13 are a further variant of bringing about securing of the engaged position. When the clamping nut 5 is tilted from the disengaged position into the engaged position, the external thread 4 of the barbell bar 2 fits in place behind the securing cams 13.

Although the present invention has been described with reference to preferred embodiments, workers skilled in the art will recognize that changes may be made in form and detail without departing from the spirit and scope of the invention.

### LIST OF REFERENCE SIGNS

1 Barbell
2 Barbell bar
3 Weight
4 External thread
5 Clamping nut
6 Through-opening
7a Internal-thread portion
7b Internal-thread portion
8 Insertion axis
9 Thread axis
10 First contact region
11 Second contact region
12 Acting lever
13 Securing cam

1. A barbell as a piece of sports equipment for training and/or for taking part in competitions, having
a bar for releasably and/or exchangeably holding weights,
wherein the bar has at least one external thread,
having at least one weight, which has an opening for sliding onto and pulling off the bar,
and having at least one clamping nut so as to hold and/or secure the respective weight, to be held on the bar, by clamping the clamping nut introduced onto the external thread with respect to the weight,
wherein
the clamping nut is in the form of a quick-clamping nut which has a through-opening with an internal thread,
wherein the through-opening is flared at the ends of the through-opening such that the quick-clamping nut
i. is displaceable along an insertion axis, which extends through the through-opening, without the internal thread being engaged with the external thread over and/or along the barbell bar, while the clamping nut is disengaged with respect to the bar and is in a disengaged position, and
ii. has a thread axis which extends through the through-opening, along which the external thread of the bar can be brought into engagement with the internal thread, wherein the thread axis intersects the insertion axis such that, by tilting the clamping nut about the intersection point of the insertion axis and the thread axis and about an axis perpendicular to the insertion axis and to the thread axis, the internal thread and the external thread can be brought into engagement and thus into an engaged position and/or can be released from one another
a securing device for securing the clamping nut in the engaged position and counter to undesired tilting and for releasing of the clamping nut from the engaged position
wherein the securing device has a tab and/or a snap-action hook and/or a spring, which:
keeps the clamping nut clamped with respect to the bar and/or
prevents the tilting of the clamping nut, which causes it to be released from the engaged position,
wherein, in particular, the tab and/or the snap-action hook and/or the spring is/are movable elastically and/or plastically relative to one another with respect to the clamping nut and bar, and/or
wherein the tab and/or the snap-action hook and/or the spring is/are integrated into the clamping nut.

3. The barbell according to claim 1, wherein the clamping nut is obtainable by 3D printing and/or injection moulding and/or die casting.

4. The barbell according to claim 1, wherein the through-opening is obtainable by drilling along the thread axis, cutting an internal thread about the thread axis and producing a thread-free through-hole along the insertion axis.

5. The barbell according to claim 1, wherein
the nominal diameter of the internal thread corresponds to the nominal diameter of the external thread, and/or
the diameter of the thread-free through-hole corresponds to the nominal diameter of the internal thread and/or of the external thread.

6. The barbell according to one of the preceding claim 1, wherein the internal thread has two partial threaded portions which are arranged opposite one another in an offset manner with respect to the thread axis, wherein the partial threaded portions each have an interrupted thread flight which has in each case an arc length of less than 360°.

7. The barbell according to claim 1, wherein the intersection point of the insertion axis and the thread axis lies between the two partial thread portions.

8. The barbell according to claim 1, wherein the clamping nut has a contact face which comprises a first and a second contact region, wherein the first contact region is formed perpendicularly to the thread axis and the second contact region is formed as a chamfer and/or as a rounding with respect to the first contact region such that, when the clamping nut is slid onto the bar, the second contact region can be brought into abutment against the weight and, when the clamping nut is tilted, in particular when the clamping nut is pivoted and/or tightened further against the weight, from the disengaged position into the engaged position, the first contact region can be brought into abutment against the weight, wherein, in particular, the chamfer forms a planar face perpendicular to the insertion axis.

9. The barbell according to claim 1, wherein the lateral face of the body of the clamping nut has at least one acting lever, extending in a plane perpendicular to the thread axis, for manually tightening and/or releasing the clamping nut.

10. The barbell according to claim 1, wherein the lateral face of the body of the clamping nut has at least one acting lever, extending in a plane defined by the thread axis and the insertion axis, for manually tilting the clamping nut from the engaged position into the disengaged position and from the disengaged position into the engaged position.

11. The barbell according to claim 1, wherein the lateral face of the body of the clamping nut has at least one C-shaped cutout for manually tightening and/or releasing and/or tilting the clamping nut.

12. The barbell according to claim 1, wherein the securing device comprises a moulded element for receiving at least a part of the lateral face of the clamping nut in a form-fitting manner, and/or a securing cam and/or securing wedge and/or a C-clip for introducing into the through-opening along and/or parallel to the thread axis and/or the insertion axis, in order to prevent the clamping nut from tilting from the engaged position into the disengaged position by itself and/or to prevent the releasing of the clamping nut from a position in abutment against the weight.

14. The barbell according to claim 5, wherein at least one partial threaded portion has at least one thread flight which has an arc length of at least 180°, in order, in the engaged position, to allow the external thread of the bar to fit together with the internal thread by the retaining action of the undercut.

15. The barbell according to claim 1, wherein the clamping nut is manufactured at least partially, in particular entirely from a dimensionally stable plastic, in particular based on polyamide.
